(19) United States
(12) Patent Application Publication
(10) Pub. No.: US 2019/0195178 A1
(43) Pub. Date: Jun. 27, 2019

(54) Adsorber Element, Intake Air Filter System, and Method for Producing Such an Adsorber Element

(71) Applicant: MANN+HUMMEL GmbH, Ludwigsburg (DE)

(72) Inventor: Harald Auer, Oberschneiding (DE)

(21) Appl. No.: 16/227,622

(22) Filed: Dec. 20, 2018

(30) Foreign Application Priority Data
Dec. 21, 2017 (DE) 10 2017 011 875.2

(51) Int. Cl. F02M 35/02; F02M 35/024

(52) U.S. Cl. CPC F02M 35/0218; F02M 35/02458; F02M 35/02408; F02M 35/02416; F02M 35/02491

(57) ABSTRACT

An adsorber element for an intake air filter system of a motor vehicle is provided with a first flat filter material and a second flat filter material. Adsorber material particles are arranged between the first flat filter material and the second flat filter material. A cutout penetrates the first flat filter material and the second flat filter material. A fastening element is received in the cutout and prevents outflow of the adsorber material particles. The intake air filter system has a housing in which the adsorber element is received and non-detachably fastened to a housing wall of the housing.

### BACKGROUND OF THE INVENTION

The invention concerns an adsorber element for an intake air filter system of a motor vehicle, an intake air filter system with such an adsorber element, as well as a method for producing such an adsorber element.

Different intake air filter systems with adsorber elements are known which are used in particular for reduction of hydrocarbon (HC) emissions when the internal combustion engine of motor vehicles is turned off. These are, on the one hand, so-called “full flow” systems in which an adsorber element is stationarily arranged across an entire cross section of an intake manifold. The advantage of such an arrangement resides in that all HC emissions which are exiting after turning off the internal combustion engine are transported through the adsorber element and are adsorbed thereat to a specified proportion. A further known arrangement are so called “bypass” systems. Here, the adsorber element is mounted, for example, on a housing wall and is not flowed through but flowed across. As adsorber material, for example, activated carbon can be provided that is arranged between two flat filter materials.

### SUMMARY OF THE INVENTION

It is therefore object of the present invention to provide an improved adsorber element.

Accordingly, an adsorber element for an intake air filter system of a motor vehicle is proposed. The adsorber element comprises a first flat filter material, a second flat filter material, a plurality of adsorber material particles that are arranged between the first flat filter material and the second flat filter material, and a fastening element that is received in a cutout penetrating the first flat filter material and the second flat filter material, wherein the fastening element is configured to prevent the adsorber material particles from flowing out.

Since the fastening element is received in the cutout, a simple attachment of the adsorber element in a housing of an intake air filter system is possible. The adsorber material particles are preferably introduced as bulk material between the flat filter materials. Preferably, the fastening element is an eye or is eye-shaped. A pin-like fastening section or a snap hook can be passed through the fastening element for attachment of the adsorber element at a housing of an intake air filter system.

In embodiments, the adsorber element is a plate-shaped component. In particular, the adsorber element can also be flexible and bendable wherein, by means of one or several fastening elements, it can be attached flat against a filter housing wall.

In embodiments, the adsorber material particles are configured to adsorb hydrocarbons. In particular, the adsorber material particles are designed to adsorb gaseous hydrocarbons. The adsorber material particles can be activated carbon particles, in particular activated carbon spheres.

In embodiments, the fastening element comprises a disk-shaped first contact section that is resting on the first flat filter material, a disk-shaped second contact section that is resting on the second flat filter material, and a tubular intermediate section arranged between the contact sections and received in the cutout. The fastening element is preferably a plastic eye or metal eye. The cutout can be introduced with a punch, for example, into the flat filter materials. In particular, the adsorber material particles are arranged as a layer between the filter materials wherein the cutout extends through the layer that is formed of the adsorber material particles. Preferably, the flat filter materials are contacting radially the tubular intermediate section. The contact sections are lying flat on the filter materials and seal the adsorber element axially so that adsorber material particles also cannot exit laterally past the intermediate section.

In an embodiment as an eye-shaped fastening element, the stiffness of the fastening element predetermines a pressing force upon attachment to a housing wall. The fastening element prevents also compression of the multi-layer filter material as it may happen in the region of fastening cutouts produced exclusively by means of fusing or compaction of media material. A tensile load or the release force for removing the adsorber element from a wall is also absorbed by the fastening element and not transmitted onto the filter medium.

Moreover, the use of a fastening element for sealing a hole, cutout, or an opening in the filter media stacked on each other facilitates the manufacture of a filter arrangement because the attachment can be positioned arbitrarily.

In embodiments, the adsorber material particles are present as bulk material wherein the adsorber material particles are glued to the first flat filter material and/or to the second flat filter material. For example, the adsorber material particles can be glued by means of a hot melt adhesive to the filter materials. Moreover, the adsorber material particles can be arranged at least partially loosely between the filter materials. The fastening element can be embodied monolithic together with the flat filter materials. For example, the fastening element can be formed in that the first flat filter material is directly connected, in particular fused, welded or glued, to the second flat filter material.

In embodiments, the fastening element is a rivet, in particular a hot rivet. Hot riveting, heat staking or also warm forming is a form-fit and/or material-fused non-detachable joining method. In this context, a thermoplastic synthetic component, the hot rivet, is at least partially melted by heat input and then formed by means of a stamp. One can say that the hot rivet serves as a closure of the edges of the flat filter medium with the particles of the adsorber material positioned between or at the filter medium.

In embodiments, several fastening elements are provided which in particular are provided at rim sections of the adsorber element. For example, four fastening elements are provided. The adsorber element can be, for example, rectangular wherein a fastening element can be positioned in each corner of the adsorber element. In embodiments, at least one opening and the fastening element are arranged in a region of the multi-layer adsorber element where no circumferentially extending edge seal for preventing outflow of the adsorber particles at the outer edge is attached.

In embodiments, the first flat filter material, the second flat filter material, and the adsorber material particles form a media layer of the adsorber element wherein the adsorber element comprises several media layers. Preferably, the adsorber element comprises two to five media layers. The media layers can be connected to each other by means of several fastening elements.

In embodiments, the adsorber element is closed at the rim in order to prevent outflow of the adsorber material particles. For example, the adsorber element is closed at the rim by means of an adhesive, for example, a hot melt adhesive, or a wax material.

Moreover, an intake air filter system for a motor vehicle is proposed with a housing and an adsorber element of this kind received in the housing wherein the adsorber element, in particular by means of the fastening element, is non-detachably attached to a housing wall of the housing. Preferably, the adsorber element is fastened by means of snap hooks to the housing wall. In particular, the adsorber element is placed directly on or against the housing wall. This means that there is preferably no air gap between the adsorber element and the housing wall. Air to be cleaned flows past the adsorber element. This means that the intake air filter system is a so-called bypass adsorber system.

Moreover, a method for producing an adsorber element for an intake air filter system of a motor vehicle with the following method steps is proposed: providing a first flat filter material, a second flat filter material, a plurality of adsorber material particles, and a fastening element; arranging the adsorber material particles between the first flat filter material and the second flat filter material; introducing a cutout that penetrates the first flat filter material and the second flat filter material; and arranging the fastening element in the cutout.

The introduction of the cutout and the arrangement of the fastening element can be realized simultaneously. For example, the adsorber material particles are sprinkled onto the first flat filter material and covered with the second flat filter material. The introduction of the cutout and the arrangement of the fastening element in the cutout can also be realized in that the flat filter materials are directly connected to each other and a cutout is introduced through them at the same time. For example, the flat filter materials can be directly fused, welded or glued to each other. The cutout can be introduced by means of a punch.

Further possible implementations of the adsorber element, of the intake air filter system, and/or of the method comprise also combinations, not explicitly mentioned, of features regarding the embodiments described above or in the following or embodiments of the adsorber element, of the intake air filter system, and/or of the method. In this context, a person of skill in the art will also add or modify individual aspects as improvements or supplements to the respective basic form of the adsorber element, of the intake air filter system, and/or of the method.

Further embodiments of the adsorber element, of the intake air filter system, and/or of the method are subject matter of the dependent claims as well as of the embodiments described in the following of the adsorber element, of the intake air filter system and/or of the method. In the following, the adsorber element, the intake air filter system, and/or the method will be explained in more detail with the aid of embodiments with reference to the enclosed Figures.

### BRIEF DESCRIPTION OF THE DRAWINGS

FIG. 1 shows a schematic perspective view of an embodiment of an adsorber element.

FIG. 2 shows a further schematic perspective view of the adsorber element according to FIG. 1.

FIG. 3 shows a schematic section view of the adsorber element according to FIG. 1.

FIG. 4 shows a schematic section view of a further embodiment of an adsorber element.

FIG. 5 shows a schematic perspective view of a further embodiment of an adsorber element.

FIG. 6 shows a schematic perspective view of a further embodiment of an adsorber element.

FIG. 7 shows a schematic section view of a further embodiment of an adsorber element.

FIG. 8 shows a schematic section view of an embodiment of an intake air filter system.

FIG. 9 shows a schematic illustration of a method for producing an adsorber element.

In the Figures, same reference characters identify same or functionally the same elements, insofar as nothing to the contrary is indicated.

### DESCRIPTION OF PREFERRED EMBODIMENTS

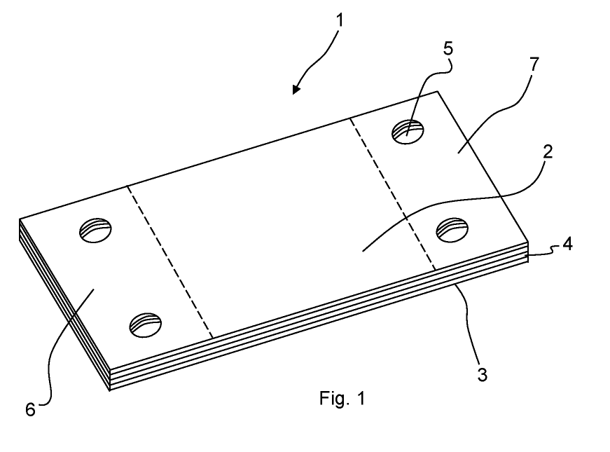

FIG. 1 shows a schematic perspective view of an adsorber element 1 for an intake air filter system of a motor vehicle. The adsorber element 1 comprises a first flat filter material 2, a second flat filter material 3, a plurality of adsorber material particles 4, and at least one fastening element not illustrated in FIG. 1. The fastening element is received in a cutout 5 which is penetrating the first flat filter material 2 and the second flat filter material 3. The number of cutouts 5 is arbitrary. As shown in FIG. 1, four cutouts 5 can be provided which preferably are provided at the rim sections 6, 7 of the adsorber element 1.

The flat filter materials 2, 3 are preferably arc-shaped. In particular, the flat filter materials 2, 3 are flexible. The flat filter materials 2, 3 can be filter nonwovens. The adsorber element 1 comprises, for example, an elongate rectangular shape. Alternatively, the adsorber element 1 can comprise an oval, round, or an arbitrary geometry.

The adsorber material particles 4 are present preferably as bulk material. The adsorber material particles 4 are glued to the first flat filter material 2 and/or the second flat filter material 3. For example, the adsorber material particles 4 can be glued by means of a hot melt adhesive to the first flat filter material 2 and/or the second flat filter material 3. The adsorber material particles 4 are preferably activated carbon particles. The adsorber material particles 4 can be spherical.

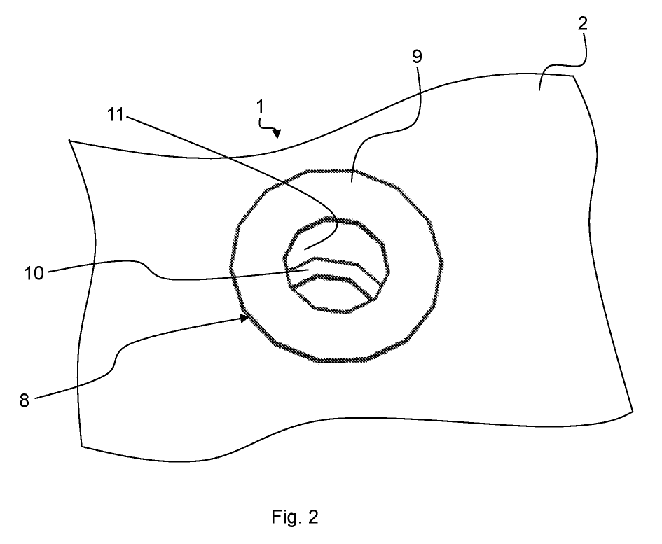

FIG. 2 shows a schematic perspective partial view of the adsorber element 1 according to FIG. 1. In the cutout 5 (FIG. 1), a fastening element 8 is arranged. The fastening element 8 is in particular a hot rivet that is manufactured of plastic material. In particular, the fastening element 8 is an eye. Alternatively, the fastening element 8 can be made of a metal material. The fastening element 8 comprises a disk-shaped first contact section 9 that is resting on the first flat filter material 2, a disk-shaped second contact section 10 that is resting on the second flat filter material 3, and a tubular intermediate section 11 which is arranged between the contact sections 9, 10.

The intermediate section 11 connects the first contact section 9 with the second contact section 10. The intermediate section 11 is received in the cutout 5. The fastening element 8 and in particular the tubular intermediate section 11 are designed to prevent, or at least reduce, outflow of the adsorber material particles 4 from between the flat filter materials 2, 3.

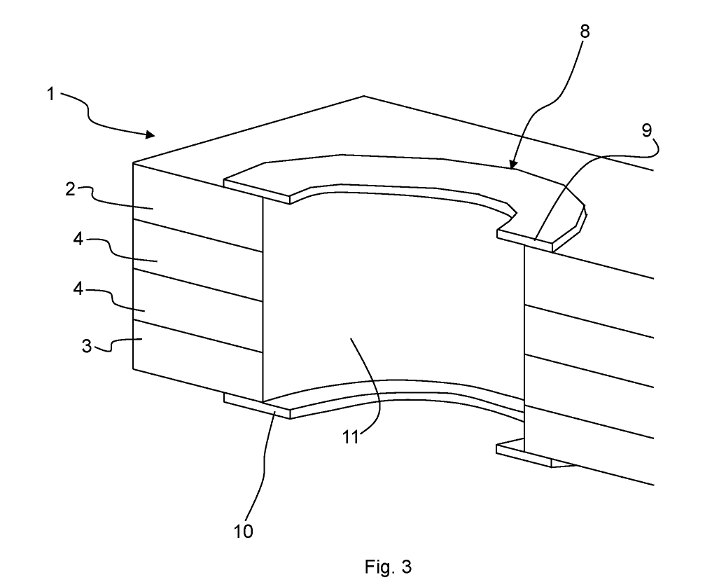

FIG. 3 shows a schematic perspective section view of the adsorber element 1. In deviation from the embodiment illustrated in FIGS. 2 and 3, the fastening element 8 can be embodied to be monolithic with the flat filter materials 2, 3. In particular, the filter materials 2, 3 can be directly welded or glued to each other so that the filter materials 2, 3 themselves form the fastening element 8.

The adsorber element 1 is preferably closed at the rim in order to prevent lateral outflow of the adsorber material particles 4. For example, the adsorber element 1 can be sealed and caulked at the rim, for example, with an adhesive, such as hot melt adhesive, wax or similar material. As shown in FIG. 3, the adsorber material particles 4 can be arranged in the form of several layers between the filter materials 2, 3. Due to the construction comprised of several layers or beds of adsorber material particles 4, a universal adaptation of the butane working capacity is possible by the number of layers. The butane working capacity of the adsorber material particles 4, in particular of activated carbon, is defined as the difference between the saturation load (butane load) and the residual load remaining after the desorption (air purging) relative to the activated carbon quantity.

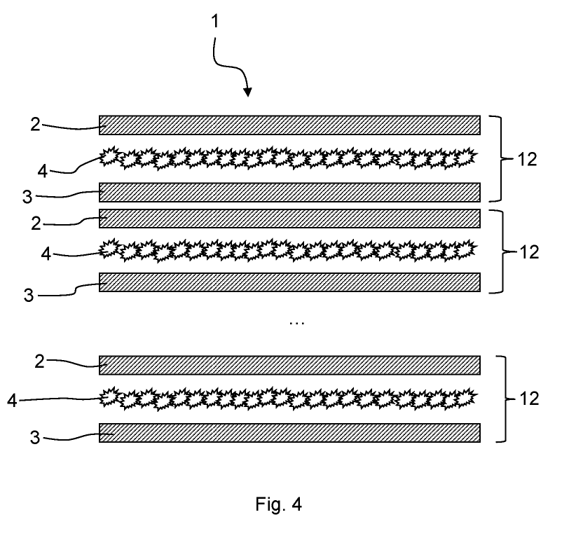

FIG. 4 shows a schematic section illustration of a further embodiment of an adsorber element 1. The first flat filter material 2, the second flat filter material 3, and the adsorber material particles 4 form a media layer 12 of the adsorber element 1. The adsorber element 1 comprises preferably several such media layers 12. The number of media layers 12 is arbitrary. Preferably two to five media layers 12 are provided.

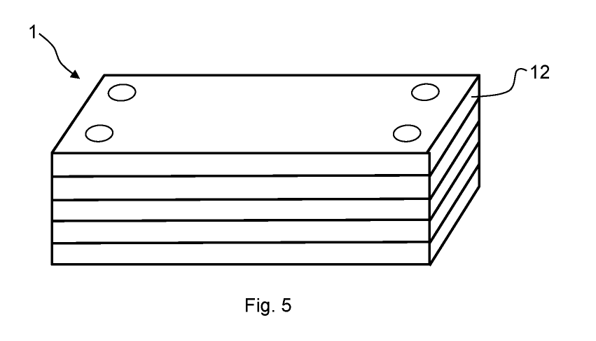

FIG. 5 shows a schematic perspective view of the adsorber element 1 according to FIG. 4. The adsorber element 1 comprises a parallelepipedal shape with five media layers 12.

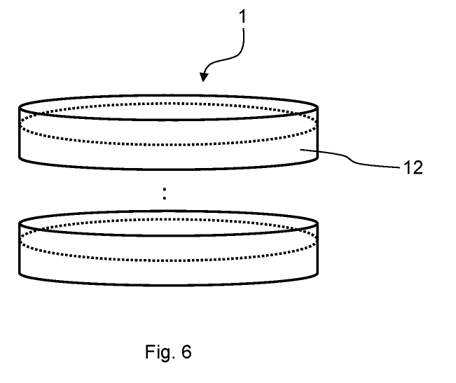

FIG. 6 shows a further embodiment of an adsorber element 1. The adsorber element 1 according to FIG. 6 differs from the adsorber element 1 according to FIG. 5 only in that the adsorber element 1 comprises a circular or elliptical shape.

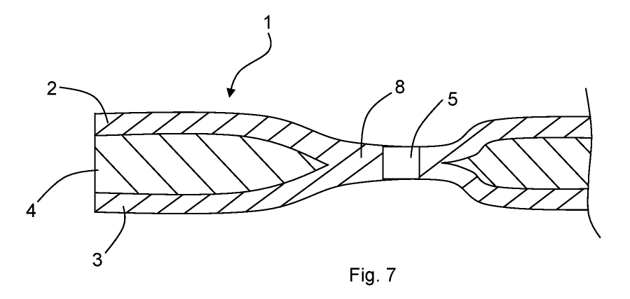

FIG. 7 shows a further embodiment of an adsorber element 1. In this embodiment of the adsorber element 1, the fastening element 8 is embodied monolithically together with the filter materials 2, 3. In particular, the fastening element 8 is formed in that the filter materials 2, 3 are fused, welded or glued to each other. The cutout 5 can be introduced before or after joining the two filter materials 2, 3. For example, the filter materials 2, 3 can be connected to each other by means of a heated punch, whereby at the same time the cutout 5 is introduced.

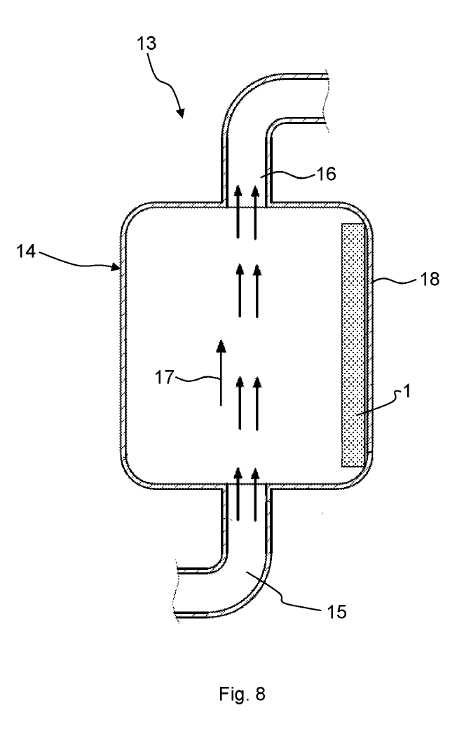

FIG. 8 shows an embodiment of an intake air filter system 13 for a motor vehicle. The intake air filter system 13 comprises a housing 14 with an air supply 15 and an air outlet 16. In a flow direction 17, the housing 14 is flowed through from the air supply 15 in the direction toward the air outlet 16.

At a side wall or housing wall 18 of the housing 14, at least one adsorber element 1 is arranged. The adsorber element 1 is received in the housing 14. The at least one adsorber element 1 is fastened to the housing wall 18 in a non-detachable way. In particular, the adsorber element 1 is fastened by means of snap hooks to the housing wall 18.

The adsorber element 1 is suitable to adsorb hydrocarbons that are contained in the air flowing through the housing 14. The adsorber element 1 is in particular a so-called bypass filter.

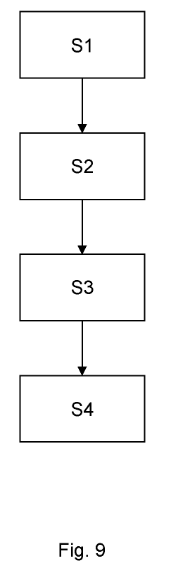

FIG. 9 shows schematically a method for producing an adsorber element 1. The method comprises a method step S1 of providing the first flat filter material 2, the second flat filter material 3, a plurality of adsorber material particles 4, and the fastening element 8.

In a method step S2, the adsorber material particles 4 are arranged between the first flat filter material 2 and the second flat filter material 3. In particular, the adsorber material particles 4 can be glued to the first flat filter material 2 and/or the second flat filter material 3.

In a method step S3, in the first flat filter material 2 and the second flat filter material 3 the cutout 5 is introduced that penetrates them. The cutout 5 can be introduced, for example, by means of a punch.

In a method step S4, the fastening element 8 is arranged in the cutout 5. The fastening element 8 can be introduced into the filter material 2, 3 simultaneously with the introduction of the cutout 5. Moreover, the fastening element 8 can be provided and introduced into the cutout 5 in that the flat filter materials 2, 3 are directly connect to each other, in particular directly welded to each other.

While specific embodiments of the invention have been shown and described in detail to illustrate the inventive principles, it will be understood that the invention may be embodied otherwise without departing from such principles.

What is claimed is:

1. An adsorber element for an intake air filter system of a motor vehicle, the adsorber element comprising:
a first flat filter material;
a second flat filter material;
adsorber material particles arranged between the first flat filter material and the second flat filter material;
a cutout penetrating the first flat filter material and the second flat filter material;
a fastening element received in the cutout, wherein the fastening element is configured to prevent outflow of the adsorber material particles.

2. The adsorber element according to claim 1, wherein the adsorber material particles are configured to adsorb hydrocarbons.

3. The adsorber element according to claim 1, wherein the fastening element comprises a disk-shaped first contact section resting on the first flat filter material; a disk-shaped second contact section resting on the second flat filter material; and a tubular intermediate section arranged between and connected to the first and second contact sections, wherein the tubular intermediate section is received in the cutout.

4. The adsorber element according to claim 1, wherein the adsorber material particles are bulk material and wherein the adsorber material particles are glued to the first flat filter material; to the second flat filter material; or to the first and second flat filter materials.

5. The adsorber element according to claim 1, wherein the fastening element is a rivet.

6. The adsorber element according to claim 5, wherein the rivet is a hot rivet.

7. The adsorber element according to claim 1, wherein a plurality of said fastening element are provided.

8. The adsorber element according to claim 7, wherein the plurality of said fastening element are arranged at rim sections of the adsorber element.

9. The adsorber element according to claim 1, wherein the first flat filter material, the second flat filter material, and the adsorber filter particles form a media layer, wherein the adsorber element comprises a plurality of said media layer.

10. The adsorber element according to claim 1, wherein the adsorber element comprises a rim and the rim is closed to prevent outflow of the adsorber material particles.

11. An intake air filter system for a motor vehicle, the intake air filter system comprising:
a housing;
an adsorber element comprising a first flat filter material; a second flat filter material; adsorber material particles arranged between the first flat filter material and the second flat filter material; a cutout penetrating the first flat filter material and the second flat filter material; a fastening element received in the cutout, wherein the fastening element is configured to prevent outflow of the adsorber material particles;
wherein the adsorber element is received in the housing and is non-detachably fastened to a housing wall of the housing.

12. The intake air filter system according to claim 11, wherein the adsorber element is fastened to the housing wall by the fastening element.

13. A method for producing an adsorber element for an intake air filter system of a motor vehicle, the method comprising:
providing a first flat filter material, a second flat filter material, adsorber material particles, and a fastening element;
arranging the adsorber material particles between the first flat filter material and the second flat filter material;
introducing a cutout in the first flat filter material and the second flat filter materials so that the cutout penetrates the first flat filter material and the second flat filter material;
arranging the fastening element in the cutout.
